(19) United States
(12) Patent Application Publication
(10) Pub. No.: US 2013/0321619 A1
(43) Pub. Date: Dec. 5, 2013

(54) ELECTRONIC DEVICE WITH DISTANCE MEASURING FUNCTION AND METHOD THEREOF

(71) Applicant: MING-JU LEE, Tu-Cheng (TW)

(72) Inventor: MING-JU LEE, Tu-Cheng (TW)

(73) Assignee: HON HAI PRECISION INDUSTRY CO., LTD., Tu-Cheng (TW)

(21) Appl. No.: 13/584,770

(22) Filed: Aug. 13, 2012

(30) Foreign Application Priority Data
May 30, 2012 (TW) 101119401

(51) Int. Cl. H04N 7/18

(52) U.S. Cl. 348/135; 348/E07.085

(57) ABSTRACT

A method for measuring distance includes: obtaining an image of an object and detecting whether the image of the object is clear when a camera module is initialed to capture the image of the object; controlling a lens to move along a center axis of the lens barrel when detecting the image of the object is not clear, and controlling the lens to stop moving when detecting the image of the object is clear; obtaining an image distance variation, and calculates a current image distance according to the image distance variation and a initial image distance; calculating a current object distance according to the current image distance, a focal distance, and a formula 1/u=1/f-1/v, wherein, u is the current objection distance, f is the focal distance, v is the current image distance.

### BACKGROUND

1. Technical Field

The present disclosure relates to electronic devices and, particularly, to an electronic device with distance measuring function and a method for the distance measuring function.

2. Description of Related Art

Usually, when people measure a distance between two objects, the usual method is to use an electronic device equipped with infrared sensors or other sensors to measure the distance between one object positioning the electronic device and the other object. However, the electronic device for such purpose is usually expensive.

An electronic device with distance measuring function, to overcome the described limitations is thus needed.

### BRIEF DESCRIPTION OF THE DRAWINGS

Many aspects of the present disclosure are better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a block diagram of an electronic device with a distance measuring function, in accordance with an exemplary embodiment.

FIG. 2 is schematic diagram showing working principles when an object is captured by a camera module of the electronic device of FIG. 1, in accordance with an exemplary embodiment.

FIG. 3 is a schematic diagram showing a viewfinder frame displayed by a display of the electronic device of FIG. 1, in accordance with an exemplary embodiment.

FIG. 4 is flowchart illustrating a method for measuring distance between two objects, in accordance with an exemplary embodiment.

### DETAILED DESCRIPTION

Embodiments of the present disclosure will be described with reference to the accompanying drawings.

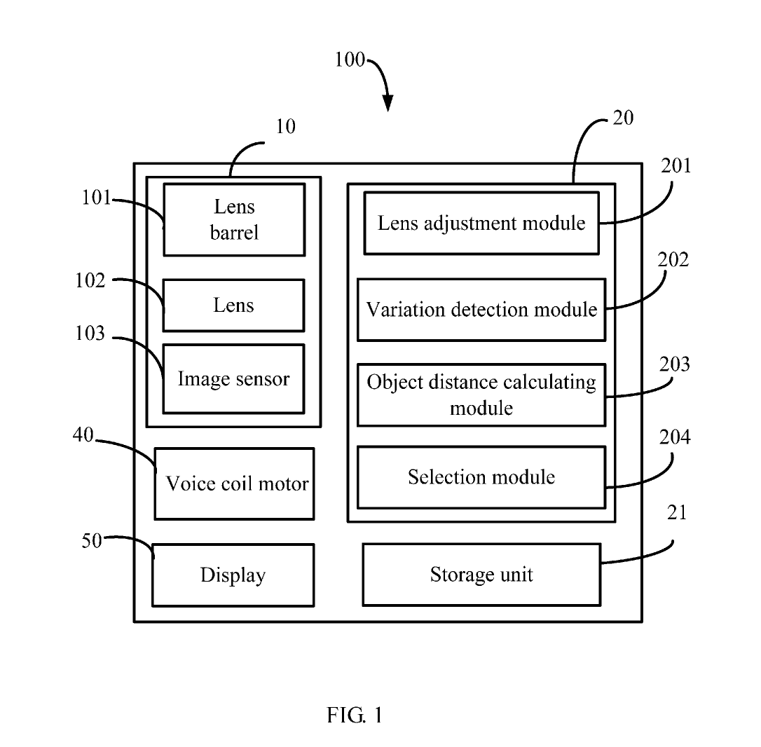

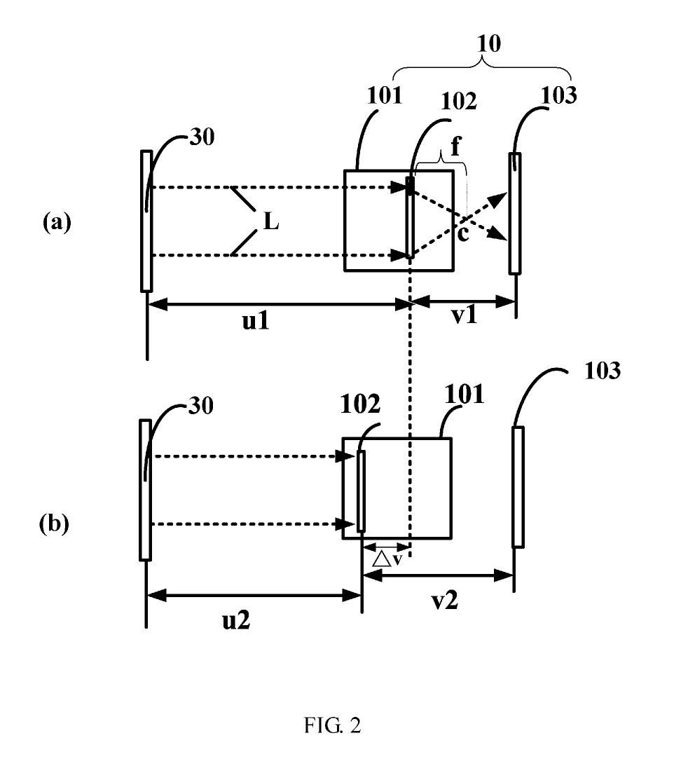

Referring to FIGS. 1-3, an electronic device 100 with distance measuring function is illustrated. The electronic device 100 includes a camera module 10 and a processing unit 20, and a storage unit 21. The camera module 10 includes a lens barrel 101, a lens 102, and an image sensor 103. The lens is located in the lens barrel 201. The image sensor 103 can be charge coupled device (CCD) or a complementary metal-oxide semiconductor (CMOS). The camera module 10 is used to capture an image of an object 30 in the front of the camera module 10 and the electronic device 100 measures a distance between the electronic device 100 and the object 30 by calculating an object distance of the object 30. In general, as shown in FIG. 2, each one of the object distances ul and u2 is a distance between the lens 102 and the object 30, thus the object distance is substantial equal to the distance between the electronic device 100 and the object 30. In the embodiment, the electronic device 100 can be a mobile phone, a tablet computer, an electronic reader, a digital photo frame, or a digital camera, for example.

The storage unit 21 stores a focal distance f and an initial image distance v1. In the embodiment, the focal distance f is a certain value which is determined by parameters of the lens 102, such as a shape, a material of the lens 102. As shown in FIG. 2, when the camera module 10 captures the image corresponding to the object 30, parallel incident lights L pass through the lens 202 and focus to a focal point C. The distance between a central point of the lens 102 and the focal point C is the focal distance f of the camera module 10. In the embodiment, the initial image distance v1 is the image distance when the camera module 10 is initialed to capture the image of the object 40. As is known, as shown in FIG. 2, the image distances v1 and v2 are the distance between the lens 102 and a surface of the image sensor 103.

The processing unit 20 includes a lens adjustment module 201, a variation detection module 202, and an object distance calculating module 203.

When the camera module 10 is initialed to capture the image of the object 30, incident lights L of the objects 30 pass through the lens 102 and transmitted to the image sensor 203 to form image of the object 30. The lens adjustment module 201 is used to obtain the image of the object 30 and detect whether the image of the object 30 is clear, namely detect whether the object 30 is clearly imaged when the camera module 10 is initialed. The lens adjustment module 201 is also used to control the lens 102 to move along a center axis of the lens barrel 101 when detecting the image of the object 30 is not clear until the image of the object 30 is clear.

In the embodiment, the lens adjustment module 201 detects whether an outline of the image of the object 30 is clear to determine whether the image of the object 30 is clear. The lens adjustment module 201 controls the image distance back to the initial image distance V1 when the camera module 10 captures an image of another object.

The variation detection module 202 is used to obtain an image distance variation Δv and calculate a current image distance v2 according to the image distance variation Δv and the initial image distance v1, when the lens adjustment module 201 detects that the image of the object 30 is clear. In the embodiment, when the lens 102 is controlled to move away from the image sensor 103, the variation detection module 202 obtains the image distance variation Δv and subtracting the image distance variation Δv from the initial image distance v1 to obtains the current image distance v2. When the lens 102 is controlled to move toward to the image sensor 103, the variation detection module 202 obtains the image distance variation Δv and pluses the image distance variation Δv with the initial image distance v1 to obtains the current image distance v2. As shown in FIG. 2, for example, initially, the image distance is v1 as shown in (a), when the lens 102 is controlled to move along the center axis of the lens barrel 101 and move away from the image sensor 103, the distance between the lens 102 and a surface of the image sensor 103 is changed, thereby producing the image distance variation Δv as shown in (b). Then the variation detection module 202 obtains the image distance variation Δv and subtracting the image distance variation Δv from the initial image distance v1 to obtains the current image distance v2.

The object distance calculating module 203 is used to calculate a current object distance u2 according to the current image distance v2, the focal distance f, and a formula 1/u=1/f-1/v. Therein, “u” is the objection distance, f is the focal distance, and v is the image distance. As described, the object distance is substantial equal to the distance between the electronic device 100 and the object 30, then, the current object distance u2 can be considered to the distance between the object 30 and the electronic device 100.

In the embodiment, the electronic device 100 also includes a voice coil motor (VCM) 40, the lens adjustment module 201 outputs pulse signals to the VCM 40, and controls the VCM 40 to drive the lens 102 to move along the center axis of the lens barrel 101 when detecting the image of the object 30 is not clear. As is known, the VCM 40 is a stepper motor, when the lens adjustment module 201 outputs a pulse signal to the VCM 40, the VCM 40 drives the lens 102 to move a certain distance. The variation detection module 202 obtains the image distance variation Δv according to an amount of the pulse signal output by the lens adjustment module 201.

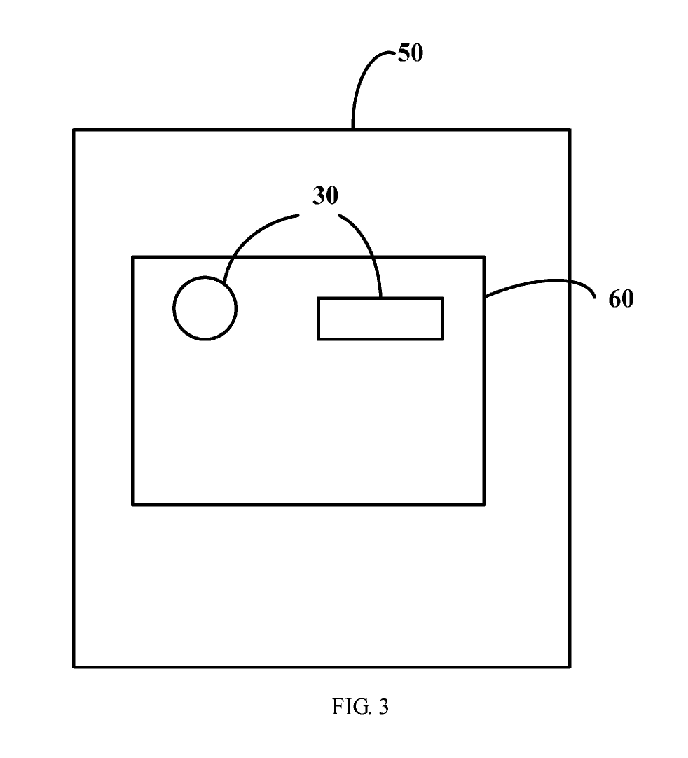

As shown in FIG. 3, in the embodiment, the electronic device 100 also includes a display 50, the processing unit 20 also includes a selection module 204. The display 50 includes a viewfinder frame 60, the viewfinder frame is used to display the image of at least one object 30, when the camera module 10 captures the image of the at least one object 30. The selection module 204 is used to select one object 30 in response to user's selection, when the viewfinder frame 60 displays a number of objects 30. For example, the display 50 can be a touch screen, the selection module 204 detects touches on the display 50 to determine the object 30 to be selected. Therefore, the lens adjustment module 201, the variation detection module 202, and the object distance calculating module 203 execute their functions as described above to obtain the object distance of the selected object 30.

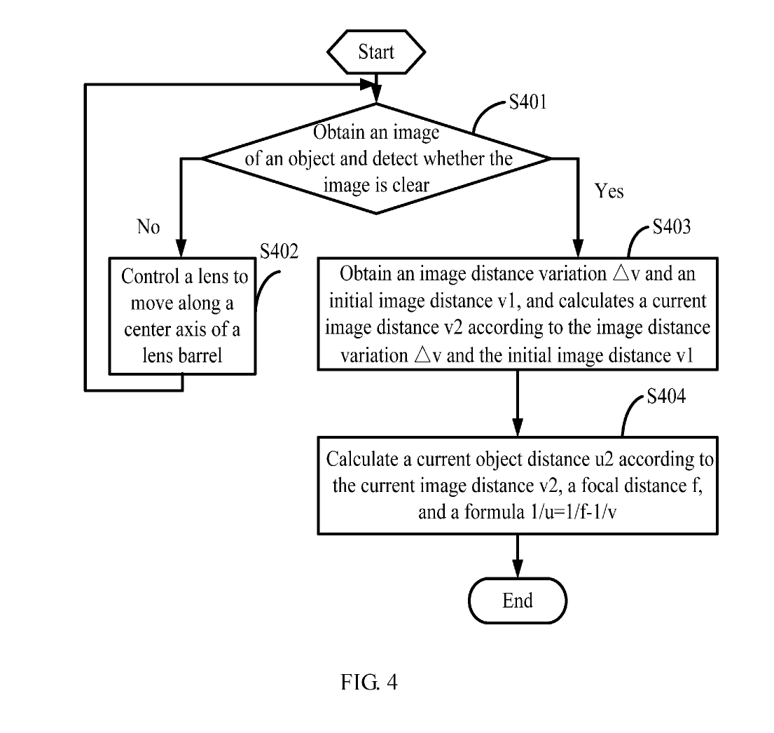

Referring to FIG. 4, a flowchart illustrating a method for measuring distance between two objects is shown. The method is applied in the electronic device 100 as shown in FIG. 1, and the electronic device 100 is one of the two objects. In step S401, the lens adjustment module 201 obtains the image of the object 30 and detects whether the image of the object 30 is clear, when the camera module 10 is initialed to capture the image of the object 30. In the embodiment, the lens adjustment module 201 detects whether the profile of the image of the object 30 is clear to determine whether the image of the object 30 is clear.

If the lens adjustment module 201 detects that the image of the object 30 is clear, the process jumps to step S403. Otherwise, in step S402, the lens adjustment module 201 controls the lens 102 to move along the center axis of the lens barrel 101 when detecting the image of the object 30 is not clear, and the process returns to step S401.

In step S403, the variation detection module 202 obtains the image distance variation Δv, and calculates the current image distance v2 according to the image distance variation Δv and the initial image distance v1 stored in the storage unit 21.

In step S404, the object distance calculating module 203 calculates the current object distance u2 according to the current image distance v2, the focal distance f, and a formula 1/u=1/f-1/v, thereby obtaining the distance between the electronic device 100 and the object 30.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. An electronic device with distance measuring function, comprising:
a camera module comprising a lens barrel, a lens located in the lens barrel, and an image sensor;
a storage unit storing a focal distance and an initial image distance; and
a processing unit comprising:
a lens adjustment module, configured to obtain the image of the object and detect whether the image of the object is clear when the camera module is initialed, control the lens to move along a center axis of the lens barrel when detecting the image of the object is not clear until the image of the object is clear;
a variation detection module, configured to obtain an image distance variation when the lens stops moving, and calculate a current image distance according to the image distance variation and the initial image distance stored in the storage unit; and
an object distance calculating module, configured to calculate a current object distance according to the current image distance, the focal distance stored in the storage unit, and a formula 1/u=1/f-1/v, wherein, u is the current objection distance, f is the focal distance, and v is the current image distance.

2. The electronic device according to claim 1, wherein, the lens adjustment module detects whether an outline of the image of the object is clear to determine whether the image of the object is clear.

3. The electronic device according to claim 1, further comprising a voice coil motor (VCM), wherein the lens adjustment module outputs pulse signals to the VCM, and controls the VCM to drive the lens to move along the center axis of the lens barrel when detecting the image of the object is not clear.

4. The electronic device according to claim 3, wherein the variation detection module obtains the image distance variation according to an amount of the pulse signals output by the lens adjustment module.

5. The electronic device according to claim 1, further comprising a display, wherein the processing unit further comprises a selection module, the display comprises a viewfinder frame for displaying the image of at least one object, the selection module is configured to select one object in response to user's selection, when the viewfinder frame displays a number of objects.

6. The electronic device according to claim 1, wherein the image sensor is a charge coupled device or a complementary metal-oxide semiconductor.

7. The electronic device according to claim 1, wherein the electronic device is one selected from the group consist of a mobile phone, a tablet computer, an electronic reader, a digital photo frame, and a digital camera.

8. A method for measuring distance between an electronic device and an object, the electronic device comprises:
a camera module comprising a lens barrel, a lens located in the lens barrel, and an image sensor;
a storage unit storing a focal distance and an initial image distance the method comprising:
obtaining an image of an object and detecting whether the image of the object is clear when the camera module is initialed to capture the image of the object;
controlling the lens to move along a center axis of the lens barrel when detecting the image of the object is not clear until the image of the object is clear;
obtaining an image distance variation, and calculates a current image distance according to the image distance variation and the initial image distance stored in the storage unit;
calculating a current object distance according to the current image distance, the focal distance stored in the storage unit, and a formula 1/u=1/f-1/v, wherein, u is the current objection distance, f is the focal distance, v is the current image distance.

9. The method according to claim 8, wherein the electronic device further comprises wherein the electronic device further comprises a voice coil motor (VCM), the step of “controlling the lens to move along a center axis of the lens barrel when detecting the image of the object is not clear” comprising:
outputting pulse signals to the VCM, and controls the VCM to drive the lens to move along the center axis of the lens barrel when detecting the image of the object is not clear.

10. The electronic device according to claim 9, wherein the step of “obtaining an image distance variation” comprising:
obtaining the image distance variation according to an amount of the pulse signals.

11. The electronic device according to claim 8, wherein the step of “obtaining an image of an object and detecting whether the image of the object is clear” comprising:
detecting whether an outline of the image of the object is clear to determine whether the image of the object is clear.
